(19) United States
(12) Patent Application Publication
(10) Pub. No.: US 2023/0086848 A1
(43) Pub. Date: Mar. 23, 2023

(54) DETERMINING SYSTEM

(71) Applicant: FANUC CORPORATION, Yamanashi (JP)

(72) Inventor: Junichi TEZUKA, Yamanashi (JP)

(73) Assignee: FANUC CORPORATION, Yamanashi (JP)

(21) Appl. No.: 17/904,461

(22) PCT Filed: Mar. 24, 2021
(86) PCT No.: PCT/JP2021/012400

§ 371 Date: Aug. 17, 2022

(30) Foreign Application Priority Data
Mar. 27, 2020 (JP) 2020-058165

(51) Int. Cl. G01B 21/20; B23Q 17/20

(52) U.S. Cl. CPC G01B 21/20; B23Q 17/20

(57) ABSTRACT

The present invention quickly determines causes of shape errors, machined surface defects, etc. by comparing the machined surface shape calculated on the basis of the actual motor position, and the machined surface shape obtained by actually measuring the machined surface of a machined workpiece. This determining system is equipped with: a motor position acquisition unit for acquiring the actual position of a motor for driving the drive shaft of a machine tool; a tool information acquisition unit for acquiring tool information which includes the machine tool driveshaft configuration, the instrument shape and the unmachined workpiece shape; a motor position machined surface calculation unit for calculating the shape of the machined surface of the machined workpiece on the basis of the tool information and the actual position of the motor; an actual machined surface acquisition unit for acquiring the shape of the machined surface of an actually machined workpiece; and a machined surface analysis unit for comparing a first correlation, which is the correlation between the shape of the machined surface calculated by the motor position machined surface calculation unit and the shape of the machined surface acquired by the actual machined surface acquisition unit.

### TECHNICAL FIELD

The present invention relates to a system for determining a cause of a machined surface defect, a shape error, etc.

### BACKGROUND ART

It has been known that the accuracy of controlling the position of a motor that drives each drive shaft of a machine tool greatly influences a machining result. For this reason, various techniques of determining a cause of a machined surface defect, a shape error, etc. of a workpiece machined using a machine tool have been known, for example (see, e.g., Patent Documents 1 to 3).

Patent Document 1: Japanese Patent No. 6366875

Patent Document 2: Japanese Patent No, 5197640

Patent Document 3: Japanese Unexamined Patent Application, Publication No. 2017-30066

### DISCLOSURE OF THE INVENTION

### Problems to be Solved by the Invention

However, there has been no technique of directly comparing a machined surface shape calculated based on the actual position of the motor and a machined surface shape actually measured and obtained from a machined surface of the machined workpiece, and in a current situation, it takes considerable time to specify the cause of the machined surface defect, the shape error, etc.

For this reason, there has been a demand for the technique of comparing the machined surface shape calculated based on the actual position of the motor and the machined surface shape actually measured and obtained from the machined surface of the machined workpiece to determine the cause of the machined surface defect, the shape error, etc. within a short period of time.

### Means for Solving the Problems

One aspect of the present disclosure is a determining system including a motor position acquisition unit that acquires the actual position of a motor driving a drive shaft of a machine tool, a machine information acquisition unit that acquires machine information including a drive shaft configuration of the machine tool, a tool shape, and an unmachined workpiece shape, a motor position-based machined surface shape calculation unit that calculates the shape of a machined surface of a machined workpiece based on the actual position of the motor and the machine information, an actual machined surface shape acquisition unit that actually acquires the shape of the machined surface of the machined workplace, and a machined surface analysis unit that analyzes a first correlation that is a correlation between the machined surface shape calculated by the motor position-based machined surface shape calculation unit and the machined surface shape acquired by the actual machined surface shape acquisition unit such that these machined surface shapes are compared with each other.

### Effects of the Invention

According to the present disclosure, a correlation between the machined surface shape calculated based on the actual position of the motor and the machined surface shape actually measured and obtained from the machined surface of the machined workpiece is analyzed such that these machined surface shapes are directly compared with each other, and therefore, the cause of the machined surface defect, the shape error, etc. can be determined within a short period of time.

### BRIEF DESCRIPTION OF THE DRAWINGS

FIG. 1 is a functional block diagram showing the configuration of a determining system according to the present embodiment;

FIG. 2 is a diagram for describing the method for calculating a reference plane for each of shapes A to D according to the present embodiment;

FIG. 3 is a diagram for describing that the shapes A to D are shown on the same coordinate system according to the present embodiment; and

FIG. 4 is a diagram for describing the method for analyzing a cause of a machined surface defect, a shape error, etc. according to the present embodiment.

### PREFERRED MODE FOR CARRYING OUT THE INVENTION

Hereinafter, one embodiment of the present disclosure will be described in detail with reference to the drawings.

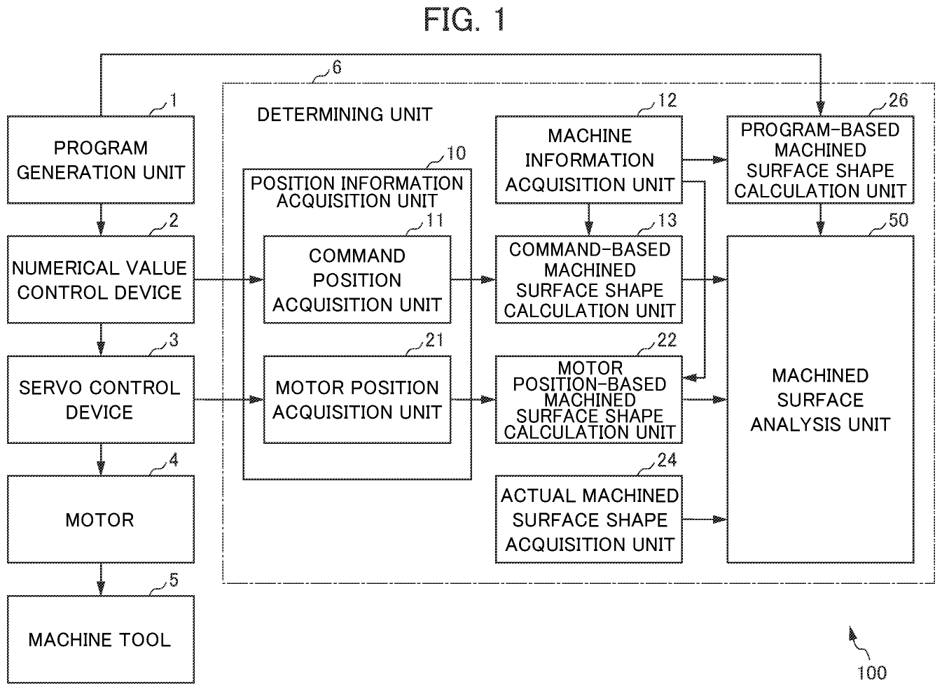

FIG. 1 is a functional block diagram showing the configuration of a determining system 100 according to the present embodiment. As shown in FIG. 1, the determining system 100 includes a program generation unit 1, a numerical value control device 2, a servo control device 3, a motor 4, a machine tool 5, and a determining unit 6.

The program generation unit 1 generates a machining program based on data on the shape of a workpiece before and after machining (an unmachined workpiece and a machined workpiece), later-described machine information, etc. The shape data includes, for example, three-dimensional computer aided design (CAD) data. The machining program includes a machining program created by computer aided manufacturing (CAM).

The numerical value control device 2 distributes a motor command position to a later-described command position acquisition unit 11 based on the machining program. Specifically, the numerical value control device 2 generates a command regarding the position of the motor 4 based on the machining program generated by the program generation unit 1. The position defined by such a position command means the command position of the motor 4 (hereinafter also merely referred to as a “command position”). Then, the numerical value control device 2 distributes the command position to the servo control device 3. The control for distributing the command includes computerized numerical control (CNC). In addition, the numerical value control device 2 stores the later-described machine information including a drive shaft configuration of the machine tool 5, a tool shape, and an unmachined workpiece shape in a rewritable memory such as an EEPROM.

The servo control device 3 controls the drive current of the motor 4 based on the position command (the command position) from the numerical value control device 2 and a position feedback detected by an encoder provided at the motor 4.

The motor 4 is provided at the machine tool 5. The motor 4 includes a motor that drives a movable portion of the machine tool 5, such as a tool feed shaft or a workpiece feed shaft. The motor 4 is provided with the encoder (not shown) that detects the rotation position (the rotation angle) of the motor 4. The rotation position detected by the encoder means the actual position of the motor 4, and is utilized as the position feedback. Since the rotation position of the motor 4 and the position of the movable portion of the machine tool 5 correspond to each other, the rotation position detected by the encoder, i.e., the position feedback, indicates the position of a tool or the position of the workpiece.

The machine tool 5 is, for example, a machine that cuts a surface of the workpiece (a machining target) with the tool such as a ball end mill. Each drive shaft of the machine tool 5 is driven by the motor 4.

Next, the determining unit 6 according to the present embodiment will be described in detail. The determining unit 6 according to the present embodiment includes an arithmetic processing device such as a computer including a CPU, a ROM, a RAM, etc. FIG. 1 shows an example where the determining unit 6 includes, for example, a computer separated from the numerical value control device 2, but the determining unit 6 may be configured integrally with the numerical value control device 2.

As shown in FIG. 1, the determining unit 6 according to the present embodiment includes a position information acquisition unit. 10, a machine information acquisition unit 12, a command-based machined surface shape calculation unit 13, a motor position-based machined surface shape calculation unit 22, an actual machined surface shape acquisition unit 24, a program-based machined surface shape calculation unit 26, and a machined surface analysis unit 50.

The position information acquisition unit 10 includes the command position acquisition unit 11 that acquires the command position of the motor 4 driving each drive shaft of the machine tool 5 and a motor position acquisition unit 21 that acquires the actual position (hereinafter sometimes merely referred to as an “actual position”) of the motor 4 driving each drive shaft of the machine tool 5. Specifically, the command position of the motor 4 is acquired from the numerical value control device 2. Moreover, the actual position of the motor 4 is acquired from the servo control device 3.

The machine information acquisition unit 12 acquires the machine information including the drive shaft configuration of the machine tool 5, the tool shape, and the unmachined workpiece shape. Specifically, such machine information is acquired from the program generation unit 1 or the numerical value control device 2. Alternatively, the machine information may be acquired by setting via direct input from a user.

The command-based machined surface shape calculation unit 13 calculates the shape of a machined surface of the machined workpiece based on the command position acquired by the command position acquisition unit 11 and the machine information acquired by the machine information acquisition unit 12.

Specifically, the command-based machined surface shape calculation unit 13 calculates a tool path based on the command position and information on the position of each drive shaft of the machine tool 5, and simulates a three-dimensional machined surface shape based on the tool shape and the unmachined workpiece shape. From a simulation result, the command-based machined surface shape calculation unit 13 acquires the shape of the machined surface of the machined workpiece.

The motor position-based machined surface shape calculation unit 22 calculates the shape of the machined surface of the machined workpiece based on the actual position acquired by the motor position acquisition unit 21 and the machine information acquired by the machine information acquisition unit 12.

Specifically, the motor position-based machined surface shape calculation unit 22 calculates a tool path based on the actual position and the information on the position of each drive shaft of the machine tool 5, and simulates a three-dimensional machined surface shape based on the tool shape and the unmachined workpiece shape. From a simulation result, the motor position-based machined surface shape calculation unit 22 acquires the shape of the machined surface of the machined workpiece.

The actual machined surface shape acquisition unit 24 actually measures and acquires the shape of the machined surface of the machined workpiece based on the machining program generated by the program generation unit 1. A measurement instrument capable of measuring the machined surface shape may only be required as a measurement instrument, and for example, the shape of the machined surface of the machined workpiece can be acquired from a measurement result obtained using, e.g., a typical well-known surface roughness meter.

The program-based machined surface shape calculation unit 26 calculates the shape of the machined surface of the workpiece based on the machining program. In the present embodiment, the program-based machined surface shape calculation unit 26 calculates the shape of the machined surface of the machined workpiece based on the position of the motor in the machining program and the machine information acquired by the machine information acquisition unit 12.

More specifically, the program-based machined surface shape calculation unit 26 calculates tool path based on the position of the motor in the machining program and the information on the position of each drive shaft of the machine tool 5, and simulates a three-dimensional machined surface shape based on the tool shape and the unmachined workpiece shape. From a simulation result, the program-based machined surface shape calculation unit 26 acquires the shape of the machined surface of the machined workpiece.

The machined surface analysis unit 50 analyzes a third correlation that is a correlation between the machined surface shape (hereinafter sometimes merely referred to as a “shape A”) calculated by the program-based machined surface shape calculation unit 26 and the machined surface shape (hereinafter sometimes merely referred to as a “shape B”) calculated by the command-based machined surface shape calculation unit 13, a second correlation that is a correlation between the machined surface shape (the shape B) calculated by the command-based machined surface shape calculation unit 13 and the machined surface shape (hereinafter sometimes merely referred to as a “shape C”) calculated by the motor position-based machined surface shape calculation unit 22, and a first correlation that is a correlation between the machined surface shape (the shape C) calculated by the motor position-based machined surface shape calculation unit 22 and the machined surface shape (hereinafter sometimes merely referred to as a “shape D”) acquired by the actual machined surface shape acquisition unit 24, thereby analyzing a cause of a machined surface defect, a shape error, etc.

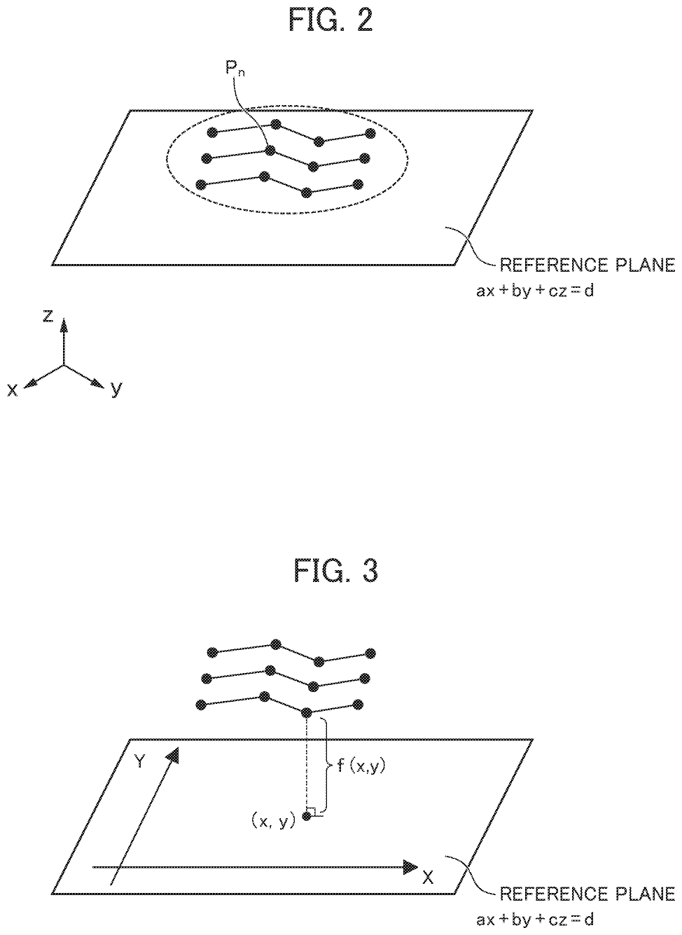

The machined surface analysis unit 50 preferably shows the shapes A to D on the same coordinate system for the sake of easy analysis of the correlations among the shapes A to D for comparing the shapes A to D. One example of the method for showing the shapes A to D on the same coordinate system will be described with reference to FIGS. 2 and 3. FIG. 2 is a diagram for describing the method for calculating a reference plane for each of the shapes A to D. FIG. 3 is a diagram for describing that the shapes A to D are shown on the same coordinate system.

For showing the shapes A to D on the same coordinate system, the reference plane for each machined surface shape needs to be calculated. Thus, the method for calculating a reference plane equation from a point cloud on a target machined surface will be described. First, a distance in from a point Pn on the machined surface to a reference plane d is represented by Equation (1) below, assuming that the point Pn on the machined surface is defined as (Xn, Yn, Zn) and the reference plane d is defined as d=aX+bY+cZ.

1n=|aXn+bYn+cZn−d|/sqrt(a²+b²+c²) Equation (1)

A plane that the square sum L of the distance from each machining point is the minimum is taken as the reference plane. That is, a, b, c, and d where I represented by Equation (2) below is the minimum are obtained.

L=Σ1n² Equation (2)

Specifically, a matrix A is defined as in Equation (3) below, and singular value decomposition (SVD) is performed using the matrix A. As a result, the reference plane is calculated.

$$A = ( \begin{matrix}X 1 & Y 1 & Z 1 \\ X 2 & Y 2 & Z 2 \\ ⋮ & ⋮ & ⋮ \\ Xn & Yn & Zn\end{matrix} ) \qquad Equation ( 3 )$$

A vector v corresponding to the minimum singular value σ is a vector normal to the reference plane to be obtained. With v=(a, b, c), the reference plane d can be calculated using Equation (4) below.

d=1/nΣ(aXn+bYn+cZn) Equation (4)

The method for calculating the reference plane from the coordinate value of the point cloud has been described above, but the present invention is not limited to above. For example, an ideal machined surface may be set from the outside, and may be taken as the reference plane.

After the reference plane has been calculated as described above, a coordinate system (an X-axis and a Y-axis) is subsequently newly set on the calculated reference plane. A function representing surface roughness information z on a point (x, y) orthogonally projected on the reference plane from the machining point is defined as in Equation (5) below.

=f(x,y) Equation (5)

In this manner, a function representing surface roughness information on the shape A can be defined as

z=f_{A}(x, y)

a function representing surface roughness information on the shape B can be defined as

z=f_{B}(x,y),

a function representing surface roughness information on the shape C can be defined as

z=f_{B}(x, y),

and
a function representing surface roughness information on the shape D can be defined as

z=f_{D}(x, y)

The machined surface analysis unit 50 calculates a correlation between the function (z=f_{A}(x, y)) representing the surface roughness information on the shape A and the function (z=f_{B}(x,y)) representing the surface roughness information on the shape B, thereby analyzing the correlation (the third correlation) between the shape A and the shape B such that these shapes are compared with each other. The same also applies to the correlation (the second correlation) between the shape B and the shape C and the correlation (the first correlation) between the shape C and the shape D.

The machined surface analysis unit 50 calculates the correlation in the surface roughness information between the machined surfaces by means of a general technique, of calculating a correlation between images. The general technique of calculating a correlation between two images A(x, y), B (x, y) includes methods using Equations (6) to (8) below. Equation (6) shows a technique called sum of absolute difference (SAD), Equation (7) shows a technique called sum of squared difference (SSD), and Equation (8) shows a technique called normalized cross-correlation (NCC).

$$SAD = {\sum }_{y} {\sum }_{x} \vert A ( x , y ) - B ( x , y ) \vert \qquad Equation ( 6 )$$

$$SSD = {\sum }_{y} {\sum }_{x} {( A ( x , y ) - B ( x , y ) )}^{2} \qquad Equation ( 7 )$$

$$NCC = \frac{{\sum }_{y} {\sum }_{x} A ( x , y ) B ( x , y )}{\sqrt{{\sum }_{y} {\sum }_{x} {A ( x , y )}^{2} {\sum }_{y} {\sum }_{x} {B ( x , y )}^{2}}} \qquad Equation ( 8 )$$

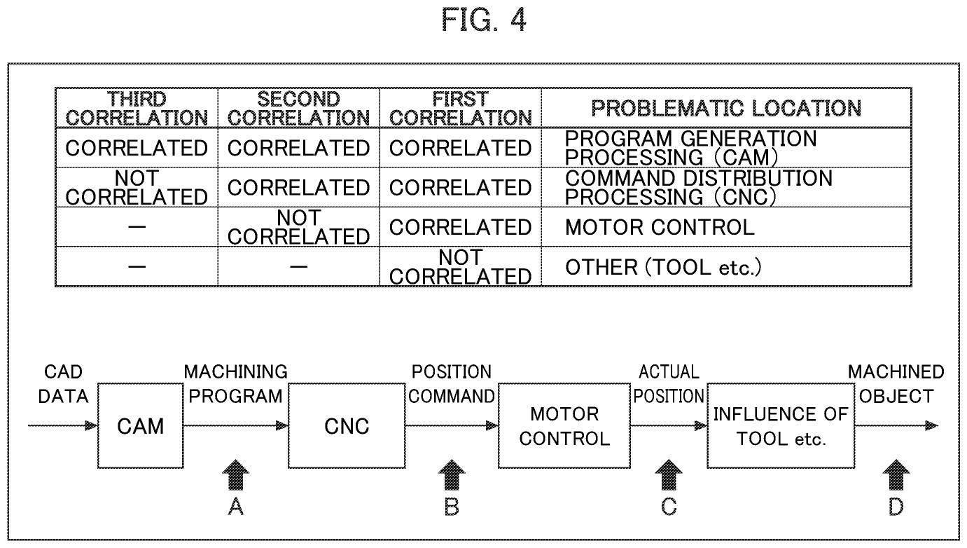

Subsequently, the method for analyzing the cause of the machined surface defect, the shape error, etc. by the robot control device 50 will be described using FIG. 4. FIG. 4 is a diagram for describing the method for analyzing the cause of the machined surface defect, the shape error, etc. according to the present embodiment.

As shown in FIG. 4, the shape A is the machined surface shape calculated based on the machining program, the shape B is the machined surface shape calculated based on the command position, the shape C is the machined surface shape calculated based on the actual position, and the shape D is the actual shape of the machined surface of the machined workpiece.

In a case where the machined surface defect or the shape error is found on the machined workpiece, the machined surface analysis unit 50 analyzes the correlation between the shape C and the shape D such that these shapes compared with each other. In a case where it is determined that there is no correlation, the machined surface analysis unit 50 determines other causes (e.g., the tool) as the cause of the machined surface defect, the shape error, etc. (a problematic location). The reason for this is that, for example, the tool shape is considered to have influenced the determination of no correlation between the actual position (the actual position of the motor 4) and the machined surface.

In a case where it is determined that there is a correlation between the shape C and the shape D, the machined surface analysis unit 50 analyzes the correlation between the shape B and the shape C such that these shapes are compared with each other. Then, in a case where it is determined that there is no correlation, the machined surface analysis unit 50 determines that the cause of the machined surface defect, the shape error, etc. is the servo control device 3 that controls the motor 4. The reason for this is considered to be that the determination of no correlation is made due to a discrepancy between the command position and the actual positon.

In a case where it is determined that there is a correlation between the shape B and the shape C, the machined surface analysis unit 50 analyzes the correlation between the shape A and the shape B such that these shapes are compared with each other. Then, in a case where it is determined that there is no correlation, the machined surface analysis unit 50 determines that the cause of the machined surface defect, the shape error, etc. is the numerical value control device 2 that distributes the command position of the motor 4. The reason for this is considered to be that the determination of no correlation is made due to a discrepancy between the position of the motor in the machining program and the command position of the motor 4 distributed by the numerical value control device 2.

Conversely, in a case where there is a correlation between the shape A and the shape B, the machined surface analysis unit 50 determines that the cause of the machined surface defect, the shape error, etc. is the program generation unit 1 having generated the machining program. This is because it is considered that the cause of the machined surface defect, the shape error, etc. is not the numerical value control device 2, the servo control device 3, the motor 4, and the machine tool 5.

As described above, the determining system 100 according to the present embodiment includes the motor position acquisition unit 21 that acquires the actual position of the motor 4 driving the drive shaft of the machine tool 5, the machine information acquisition unit 12 that acquires the machine information including the drive shaft configuration of the machine tool 5, the tool shape, and the unmachined workpiece shape, the motor position-based machined surface shape calculation unit 22 that calculates the shape of the machined surface of the machined workpiece based on the actual position of the motor 4 and the machine information, the actual machined surface shape acquisition unit 24 that actually acquires the shape of the machined surface of the machined workpiece, and the machined surface analysis unit 50 that analyzes the first correlation that is the correlation between the machined surface shape calculated by the motor position-based machined surface shape calculation unit 22 and the machined surface shape acquired by the actual machined surface shape acquisition unit 24 such that these shapes are compared with each other.

With this configuration, the machined surface analysis unit 50 can analyze the correlation between the machined surface shape (the shape C) calculated by the motor position-based machined surface shape calculation unit 22 and the machined surface shape (the shape D) acquired by the actual machined surface shape acquisition unit 24 such that these shapes are directly compared with each other. Thus, determination on whether or not the cause of the machined surface defect, the shape error, etc. is, for example, the tool shape can be mechanically made within a short period of time. That is, the correlation between the machined surface shape (the shape C) calculated based on the actual position of the motor and the machined surface shape (the shape)) actually measured and obtained from the machined surface of the machined workpiece is analyzed such that these shapes are directly compared with each other, and therefore, the cause of the machined surface defect, the shape error, etc. can be determined within a short period of time.

Moreover, the determining system 100 according to the present embodiment further includes the command position acquisition unit 11 that acquires the command position of the motor 4 driving the drive shaft of the machine tool 5 and the command-based machined surface shape calculation unit 13 that calculates the shape of the machined surface of the machined workpiece based on the command position and the machine information, and the machined surface analysis unit 50 analyzes the second correlation that is the correlation between the machined surface shape calculated by the command-based machined surface shape calculation unit 13 and the machined surface shape calculated by the motor position-based machined surface shape calculation unit 22 and the first correlation.

With this configuration, the machined surface analysis unit 50 can analyze the correlation (the second correlation) between the machined surface shape (the shape B) calculated by the command-based machined surface shape calculation unit 13 and the machined surface shape (the shape C) calculated by the motor position-based machined surface shape calculation unit 22 in addition co the correlation (the first correlation) between the shape C and the shape C such that these shapes are compared with each other. Thus, determination on whether the cause of the machined surface defect, the shape error, etc. is, for example, the tool shape or the servo control device can be mechanically made within a short period of time.

Further, the determining system 100 according to the present embodiment further includes the program generation unit 1 that generates the workpiece machining program and the program-based machined surface shape calculation unit 26 that calculates the shape of the machined surface of the workpiece based on the machining program, and the machined surface analysis unit 50 analyzes the third correlation that is the correlation between the machined surface shape calculated by the program-based machined surface shape calculation unit 26 and the machined surface shape calculated by the command-based machined surface shape calculation unit 13, the second correlation, and the first correlation.

With this configuration, the machined surface analysis unit 50 can analyze the correlation (the third correlation) between the machined surface shape (the shape A) calculated by the program-based machined surface shape calculation unit 26 and the machined surface shape (the shape B) calculated by the command-based machined surface shape calculation unit 13 in addition to the correlation (the first correlation) between the shape C and the shape D and The correlation (the second correlation) between the shape B and the shape C. Thus, determination on whether the cause of the machined surface defect, the shape error, etc. is, for example, the tool shape, the servo control device, the numerical value control device, or the program generation unit can be mechanically made within a short period of time.

Note that the present invention is not limited to the above-described embodiment and variations and modifications made within a scope in which the object of the present invention can be achieved are also included in the present invention.

For example, the example where the command-based machined surface shape calculation unit 13, the motor position-based. machined surface shape calculation unit 22, and the program-based machined surface shape calculation unit 26 acquire the machine information from the machine information acquisition unit 12 has been described. However, the command-based machined surface shape calculation unit 13, the motor position-based machined surface shape calculation unit 22, and the program-based machined surface shape calculation unit 26 may acquire the machine information from the program generation unit 1 or the numerical value control device 2. In this case, the program generation unit 1 or the numerical value control device 2 also functions as a machine information acquisition unit. Alternatively, the machine information may be directly input to the command-based machined surface shape calculation unit 13, the motor position-based machined surface shape calculation unit 22, or the program-based machined surface shape calculation unit 26 by the user. In this case, the command-based machined surface shape calculation unit 13, the motor position-based machined surface shape calculation unit 22, or the program-based machined surface shape calculation unit 26 also functions as a machine information acquisition unit.

Moreover, the example where the machined surface analysis unit 50 analyzes the correlation between the shape A and the shape B, the correlation between the shape B and the shape C, and the correlation between the shape C and the shape D such that these shapes are compared with each other has been described, but the present invention is not limited co this example. In addition to these correlations, the machined surface analysis unit 50 may analyze a correlation between the shape A and the shape C, a correlation between the shape A and the shape D, and a correlation between the shape B and the shape B such that these shapes are compared with each other.

### EXPLANATION OF REFERENCE NUMERALS

1 Program Generation Unit

2 Numerical Value Control Device

3 Servo Control Device

4 Motor

5 Machine Tool

6 Determining Unit

10 Position Information Acquisition Unit

11 Command Position Acquisition Unit

12 Machine Information Acquisition Unit

13 Command-Based Machined Surface Shape Calculation Unit

21 Motor Position Acquisition Unit

22 Motor Position-Based Machined Surface Shape Calculation Unit

24 Actual Machined Surface Shape Acquisition Unit

26 Program-Based Machined Surface Shape Calculation Unit

50 Machined Surface Analysis Unit

100 Determining System

1. A determining system comprising:
a motor position acquisition unit that acquires an actual position of a motor driving a drive shaft of a machine tool;
a machine information acquisition unit that acquires machine information including a drive shaft configuration of the machine tool, a tool shape, and an unmachined workpiece shape;
a motor position-based machined surface shape calculation unit that calculates a shape of a machined surface of a machined workpiece based on the actual position of the motor and the machine information;
an actual machined surface shape acquisition unit that actually acquires the shape of the machined surface of the machined workpiece;
a command position acquisition unit that acquires a command position of the motor driving the drive shaft of the machine tool;
a command-based machined surface shape calculation unit that calculates the shape of the machined surface of the machined workpiece based on the command position and the machine information, and
a machined surface analysis unit that analyzes a first correlation that is a correlation between the machined surface shape calculated by the motor position-based machined surface shape calculation unit and the machined surface shape acquired by the actual machined surface shape acquisition unit, and a second correlation that is a correlation between the machined surface shape calculated by the command-based machined surface shape calculation unit and the machined surface shape calculated by the motor position-based machined surface shape calculation unit and the first correlation.

2. (canceled)

3. The determining system according to claim 1, further comprising:
a program generation unit that generates a workpiece machining program; and
a program-based machined surface shape calculation unit that calculates the shape of the machined surface of the workpiece based on the machining program,
wherein the machined surface analysis unit analyzes a third correlation that is a correlation between the machined surface shape calculated by the program-based machined surface shape calculation unit and the machined surface shape calculated by the command-based machined surface shape calculation unit, the second correlation, and the first correlation.
